(19) United States
(12) Patent Application Publication
(10) Pub. No.: US 2015/0128591 A1
(43) Pub. Date: May 14, 2015

(54) VEHICLE HYDRAULIC ACCUMULATOR SYSTEM WITH EXHAUST ENERGY RECOVERY

(71) Applicant: Russell Wakeman, Canton, MI (US)

(72) Inventor: Russell Wakeman, Canton, MI (US)

(21) Appl. No.: 14/078,803

(22) Filed: Nov. 13, 2013

(51) Int. Cl. F02G 5/02

(52) U.S. Cl. CPC F02G 5/02
USPC 60/616

(57) ABSTRACT

An exhaust energy recovery system can include a hydraulic accumulator having an outer shell defining an internal volume containing an energy storage medium. The heat exchanger can be coupled to the outer shell and can selectively receive a flow of exhaust gas. The heat exchanger can have an inlet and outlet that can each be coupled to an exhaust pipe. A valve can be associated with the exhaust pipe upstream of the heat exchanger and a bypass passage can be in selective fluid communication with the valve to provide an exhaust gas flow path that bypasses the heat exchanger. The valve can be configured to: i) divert at least a portion of the exhaust gas through the heat exchanger thereby providing thermal energy to at least the energy storage medium of the accumulator, and/or ii) divert at least a portion of the exhaust gas through the bypass passage.

### FIELD

The present disclosure relates generally to a hydraulic accumulator for a vehicle and, more particularly, to a vehicle hydraulic accumulator system with exhaust energy recovery.

### BACKGROUND

Hydraulic hybrid vehicle systems for use to improve fuel economy can capture energy normally not utilized during braking and re-use this energy to propel the vehicle at a different time, thereby reducing fuel consumption. Hydraulic hybrid vehicle systems can include a pump that is driven by one or more of the vehicles wheels during a braking event. The pump can pump a hydraulic fluid into a hydraulic accumulator, which can be partially filled with a gas. The gas can act as a spring and can be separated from the hydraulic fluid by a bladder. During the braking event, the pump can compress the gas spring by pumping the hydraulic fluid into the hydraulic accumulator, which may increase the temperature of the gas. When motive force may later be required for propelling the vehicle, the pressurized hydraulic fluid can be provided from the hydraulic accumulator to drive the vehicle's drive wheels. However, if the increased temperature of the gas is not maintained, a loss of pressure and therefore efficiency of the hydraulic accumulator can occur. Thus, while such hydraulic hybrid vehicle systems work for their intended purpose, there remains a need for improvement in the relevant art.

### SUMMARY

In one form, an exhaust energy recovery system for a vehicle is provided in accordance with the teachings of the present disclosure. The exhaust energy recovery system can include a hydraulic accumulator, a heat exchanger, a valve and a bypass passage. The hydraulic accumulator can have an outer shell that can define an internal volume containing an energy storage medium. The heat exchanger can be coupled to the outer shell and can be adapted to selectively receive a flow of exhaust gas therethrough. The heat exchanger can have an inlet and an outlet that can each be adapted to be fluidly coupled to an exhaust pipe of the vehicle. The valve can be associated with the exhaust pipe upstream of the heat exchanger. The bypass passage can be in selective fluid communication with the valve and the exhaust pipe upstream of the valve, where the bypass passage can provide a flow path for the exhaust gas that bypasses the heat exchanger. The valve can be configured to: i) divert at least a portion of the exhaust gas through the heat exchanger thereby providing thermal energy to at least the energy storage medium of the accumulator, and/or ii) divert at least a portion of the exhaust gas through the bypass passage.

In another form, a vehicle is provided in accordance with the teachings of the present disclosure. The vehicle can include a hydraulic drive system and an exhaust energy recovery system. The hydraulic drive system can include a hydraulic accumulator having an outer shell defining an internal volume containing an energy storage medium. The exhaust energy recovery system can include a heat exchanger, a valve and a bypass passage. The heat exchanger can be coupled to the accumulator outer shell and can be adapted to selectively receive a flow of exhaust gas therethrough. The heat exchanger can include an outer shell, inlet and outlet side annular spaces, a plurality of circumferentially spaced apart axial flow fins, and an inlet and an outlet. The inlet and outlet side annular spaces can be positioned at respective opposed inlet and outlet ends of the heat exchanger. The plurality of circumferentially spaced apart axial flow fins can be positioned between the inlet and outlet side annular spaces. The inlet and outlet can fluidly couple the respective inlet and outlet side annular spaces to an exhaust pipe of the vehicle, and the valve can be associated with the exhaust pipe upstream of the heat exchanger. The bypass passage can be in selective fluid communication with the valve and can provide a flow path for the exhaust gas that bypasses the heat exchanger. The valve can be configured to: i) divert at least a portion of the exhaust gas through the heat exchanger thereby providing thermal energy to the energy storage medium of the accumulator, and/or ii) divert at least a portion of the exhaust gas through the bypass passage.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a partial schematic view of an exemplary vehicle having an exemplary hydraulic hybrid drive system with exhaust energy recovery according to the principles of the present disclosure;

FIG. 2 is a cross-sectional view of an exemplary hydraulic accumulator of the hydraulic hybrid drive system with exhaust energy recovery of FIG. 1 according to the principles of the present disclosure;

FIG. 2A is a cross-sectional view of another exemplary hydraulic accumulator of the hydraulic hybrid drive system with exhaust energy recovery of FIG. 1 according to the principles of the present disclosure; and

FIG. 3 is a side view of the exemplary hydraulic accumulator of FIG. 2 with a portion of an insulating material and shell removed according to the principles of the present disclosure.

### DESCRIPTION

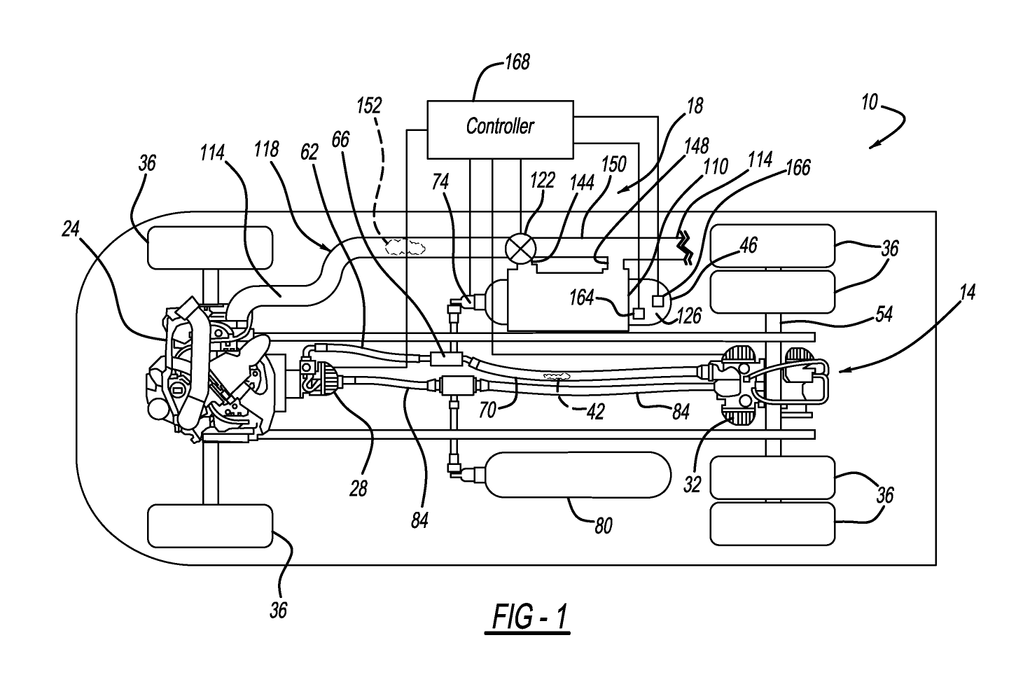

With initial reference to FIG. 1, an exemplary hydraulic hybrid vehicle is schematically shown and generally identified at reference numeral 10. The hydraulic hybrid vehicle 10 can include a hydraulic hybrid drive system 14 with exhaust energy recovery through an exhaust energy recovery system 18. As will be discussed in greater detail below, the hydraulic hybrid drive system 14 with the exhaust energy recovery system 18 can take advantage of waste heat from engine exhaust gas to maintain and/or increase the temperature of the pressurized energy storage gas in the accumulator(s) so that heat transfer to the ambient environment can be minimized and/or the waste heat from the exhaust gas can contribute thermal energy to the energy storage gas to maximize energy storage. In this way, running losses of the hydraulic hybrid system 14 can be minimized and energy storage can be restored, for example, after a vehicle 10 shutdown that would be long enough to allow the accumulator energy storage gas to cool.

With continuing reference to FIG. 1, an example architecture of the hydraulic hybrid vehicle 10 can include an internal combustion engine 24 that drives an hydraulic pump 28 and a hydraulic pump/motor 32 that drives one or more wheels 36 of vehicle 10. Power can be transmitted from or between the hydraulic pump 28 and the hydraulic pump/motor 32 by hydraulic fluid 42. As will be discussed in greater detail below, the hydraulic pump/motor 32 can be driven by recovered braking energy to pump hydraulic fluid 42 into one or more high pressure accumulators 46 for storage. It should be appreciated that while the discussion will continue with reference to vehicle 10 shown in FIG. 1, various other vehicles and/or vehicle configurations can utilize the exhaust energy recovery system 18 of the hydraulic hybrid drive system 14, including forklifts and construction vehicles.

The hydraulic pump 28 can be positioned adjacent to engine 24 as shown in FIG. 1, or can be positioned remote from engine 24. The hydraulic pump/motor 32 can be positioned proximate the one or more driven wheels 36, such as relative to a rear axle 54 of vehicle 10. In this example, the hydraulic pump/motor 32 can be coupled to the rear axle 54 and configured to drive one or more of the rear wheels 36 positioned on one or both sides of vehicle 10. It should be appreciated, however, that hydraulic pump/motor 32 can be positioned and configured to drive the front wheels 36 of vehicle 10 and/or more than one hydraulic pump/motor 32 can be utilized to selectively drive various combinations of one or more front and rear wheels of vehicle 10.

A first fluid line 62 can fluidly couple the hydraulic pump 28 to the hydraulic pump/motor 32. The first fluid line 62 can include a connection, such as a tee 66 to fluidly couple a second fluid line 70 to the first fluid line 62 and to the one or more high pressure accumulators 46. While the discussion will continue with reference to one high pressure accumulator 46, it should be appreciated that one or more high pressure accumulators 46 of the same or various sizes and shapes can be utilized in the hydraulic hybrid drive system 14. A valve 74 can be incorporated into or relative to second fluid line 70 to control flow of hydraulic fluid 42 into high pressure accumulator 46. In one exemplary implementation, the valve 74 can be positioned between the second fluid line 70 and an entrance or inlet to the high pressure accumulator 46. In this exemplary implementation, the valve 74 can be coupled to or incorporated into the high pressure accumulator 46. It should be appreciated, however, that the valve 74 can be positioned in various other locations, such as in connection 66 so as to be able to control flow of hydraulic fluid relative to high pressure accumulator 46 and hydraulic pump/motor 32.

The hydraulic hybrid drive system 14 can also include one or more low pressure hydraulic accumulators 80 that are fluidly coupled to both the hydraulic pump 28 and the hydraulic pump/motor 32. The low pressure accumulator 80 can be utilized to provide/maintain an adequate supply of low pressure hydraulic fluid 42 to the hydraulic hybrid drive system 14, such as to an input of the hydraulic pump 28, as well as compliance to the hydraulic hybrid drive system 14. In the exemplary implementation illustrated in FIG. 1, one or more fluid lines 84 can fluidly couple the low pressure accumulator 80 to the hydraulic pump 28 and the hydraulic pump/motor 32.

The high and low pressure accumulators 46, 80 can be any pressure vessel capable of containing the pressure of the hydraulic fluid and the energy storage medium therein. In one example configuration, the low pressure accumulator 80 can contain a pressure of approximately 40-50 psi, and the high pressure accumulator can contain a pressure of approximately 6000 psi. It should be appreciated, however, that the accumulators 46, 80 can be designed to accommodate various other pressures or pressure ranges as may be required by various deigns configurations of the hydraulic hybrid drive system 14.

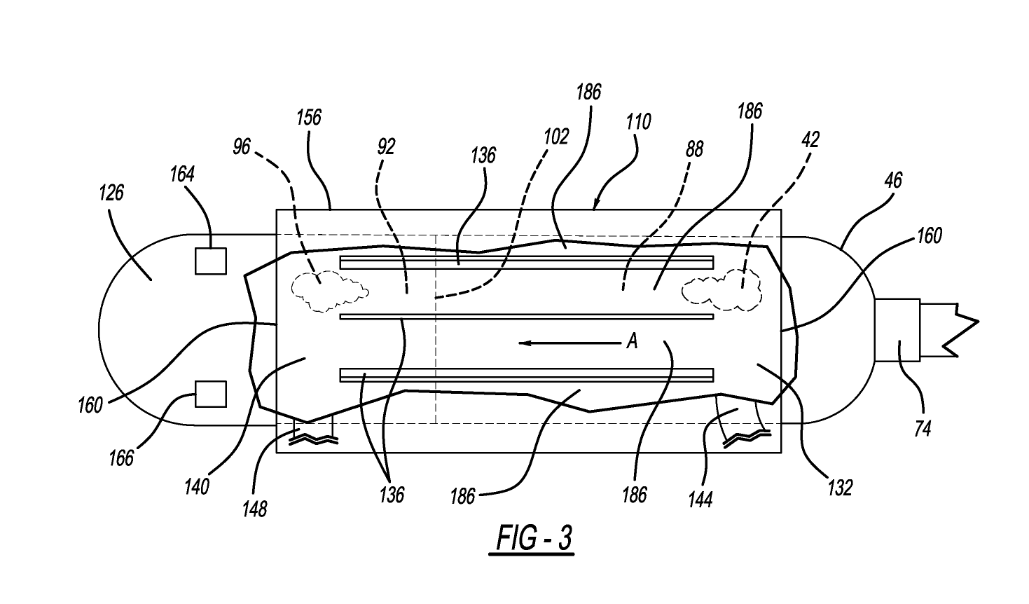

The internal volume of each accumulator 46, 80 can be divided into separated spaces 88, 92 (FIG. 3) for the hydraulic fluid 42 and the energy storage medium 96. In one exemplary implementation, the energy storage medium 96 can be an energy storage gas, such as nitrogen. The two spaces 88, 92 can be separated and isolated from each other by a flexible, movable and/or impermeable barrier 102. Examples of such a barrier 102 include pistons, bladders and bellows. In the exemplary implementation illustrated, the hydraulic fluid 42 can be associated with space 88 and the energy storage gas 96 can be associated with space 92. The barrier 102 can be capable of exchanging volume between the two spaces 88, 92 as the hydraulic hybrid drive system 14 pushes hydraulic fluid 42 into the space 88, or the energy storage gas 96 contained in space 92 pushes hydraulic fluid 42 out of space 88 and the associated accumulator.

For example, the hydraulic hybrid drive system 14 can be configured such that the hydraulic pump/motor 32 operates in a motor capacity to drive one or more wheels 36 based on hydraulic fluid 42 being pumped by hydraulic pump 28, which is driven by engine 24. In this mode of operation, valve 74 can be closed to direct hydraulic fluid pumped from hydraulic pump 28 to hydraulic pump/motor 32 to drive wheel(s) 36. It should be appreciated, however, that depending on the motive power demand and/or the state of accumulator 46, valve 74 can be controlled to be partially open to divert a portion of the pumped hydraulic fluid 42 into space 88 of high pressure accumulator 46.

During braking and/or deceleration of vehicle 10, the hydraulic pump/motor 32 can operate in a pump capacity driven by wheel(s) 36 associated with axle 54 to pump hydraulic fluid 42 into space 88 of high pressure accumulator 46 thereby reducing the volume of space 92 and thus increasing the pressure of energy storage gas 96. The pressurized hydraulic fluid 42 (via energy storage gas spring 96) in high pressure accumulator 46 can then be used to drive wheel(s) 36 by pushing the pressurized hydraulic fluid 42 to hydraulic pump/motor 32 via valve 74 commanded to an open position.

As one of ordinary skill in the art can appreciate, the energy storage gas 96 in space 92 can store energy as pressure when the hydraulic fluid 42 flows into high pressure accumulator 46 via hydraulic pump/motor 32 and expands space 88 thereby compressing the energy storage gas 96. As the energy storage gas 96 is compressed, the temperature of the energy storage gas 96 rises. If the pressure energy is recovered relatively quickly, such as opening valve 74 to release the pressurized hydraulic fluid from accumulator 46 to drive wheels 36 in the manner discussed above, the thermal energy can also be recovered. However, if this thermal energy is allowed to, for example, transfer to a case or shell of the high pressure accumulator 46 and eventually to the environment, the thermal energy can be lost. This loss of energy can result in a loss of efficiency for the pressurized hydraulic fluid stored in accumulator 46 because the pressure of the energy storage gas 96 decreases as the temperature of the pressurized energy storage gas 96 decreases.

In an effort to minimize and/or eliminate the thermal losses discussed above, the exhaust energy recovery system 18 of the hydraulic hybrid drive system 14 can be utilized to maintain and/or increase the temperature of the exhaust storage gas 96 in the high pressure accumulator 46. In one exemplary implementation, the exhaust energy recovery system 18 can use thermal energy in the form of waste heat from exhaust gas to maintain and/or increase the temperature of the energy storage gas 96 in a controlled manner, as will be discussed in more detail below.

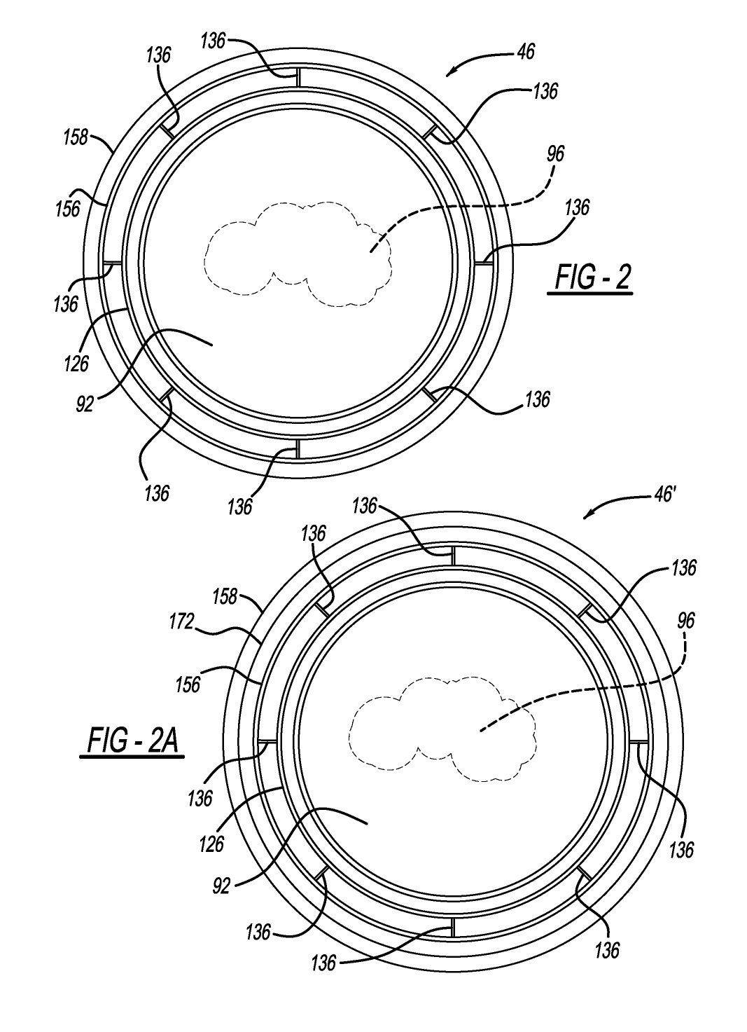

With continuing reference to FIG. 1 and additional reference to FIGS. 2-3, the exhaust energy recovery system 18 will now be discussed in greater detail in connection with the hydraulic hybrid drive system 14. The exhaust energy recovery system 18 can include a heat exchanger 110 fluidly coupled to an exhaust pipe 114 of an exhaust system 118 and a diverter valve 122. It should be appreciated that conventional components of the exhaust system 118, such as a muffler, resonator and/or catalytic converter have not been shown for clarity of illustration and discussion. One or more of such exhaust components are envisioned as part of the exhaust system 118.

With particular reference to FIG. 2, the heat exchanger 110 can, in one exemplary implementation, be an annular heat exchanger positioned around an outer circumference of the high pressure accumulator 46. The heat exchanger 110 can be positioned around the entirety of the circumference or just a portion of the circumference and can extend axially along a portion or substantially the entire or the entire axial length of the high pressure accumulator 46.

In the exemplary configuration illustrated, the heat exchanger 110 can be coupled to and/or engage an outer shell 126 of accumulator 46 as shown in FIG. 2. With additional reference to FIG. 3, the heat exchanger 110 can include a first annular space or ring 132, a plurality of axial flow fins 136 and a second annular space or ring 140. The first annular ring 132 can be fluidly coupled to the exhaust pipe 114 via an inlet pipe or portion 144 and the second annular ring 140 can be coupled to the exhaust pipe 114 via an outlet pipe or portion 148 at a position downstream of inlet pipe 144. The plurality of axial flow fins 136 can be positioned between the first and second annular spaces or flow rings 132, 140 and can be circumferentially spaced apart from each other, as shown in FIGS. 2 and 3.

The exhaust energy recovery system 18 can also include a bypass passage or pipe 150 positioned downstream of the diverter valve 122 and configured to provide an exhaust flow path that bypasses the heat exchanger 110. In the exemplary implementation illustrated, the bypass passage 150 can be positioned downstream of the diverter valve and coupled to a portion of the exhaust system 118 that extends downstream of heat exchanger 110, as shown for example in FIG. 1. As will be discussed in greater detail below, the diverter valve 122 can be controlled to direct all or a portion of the exhaust gas 152 from engine 24 into heat exchanger 110 through inlet pipe 144 fluidly coupled to valve 122, and/or all or a portion of the exhaust gas 152 through the bypass flow path avoiding heat exchanger 110 via bypass pipe 150. In one exemplary implementation, the bypass passage 150 can be parallel or substantially parallel to the high pressure accumulator 46 thereby providing for packaging efficiencies.

The annular heat exchanger 110 can include an outer shell 156 spaced apart from the outer shell 126 of accumulator 46 by the axial flow fins 136 and end portions 160 to thereby create an enclosed space for exhaust flow, as will be discussed below. In one exemplary configuration, the inlet and outlet pipes/portions 144, 148 can be fluidly coupled to exhaust pipe 114 upstream of any muffler and/or resonator associated with exhaust system 118. An insulating layer 158 can be positioned over or around the heat exchanger 110 and can be configured to insulate the high pressure accumulator 46 from the ambient environment. In one exemplary implementation, the insulating layer 158 can be an annular insulating layer and can be formed from various insulating materials/compositions, including, but not limited to, ceramic, fiberglass and/or a vacuum space arrangement filled with an inert gas.

A temperature sensor 164 can be associated with the high pressure accumulator 46 to directly or indirectly read or measure a temperature of the energy storage gas 96 contained therein. In one exemplary implementation, the temperature sensor 164 can be a thermocouple and can be positioned in the internal space 92 of accumulator 46 to directly measure the temperature of energy storage gas 96, or can be positioned on or in outer shell 126 to measure a temperature of the shell 126, which can be used to calculate or estimate the internal temperature of the energy storage gas 96. The temperature sensor 164, diverter valve 122 and hydraulic pump/motor can be in communication with a controller 168, such as a powertrain controller, which will be discussed in greater detail below in connection with operation of the exhaust energy recovery system 18. The high pressure accumulator 46 can also include one or more pressure sensors 166 associated therewith and configured to sense or measure an internal pressure within the accumulator 46.

With particular reference to FIG. 2A, another example configuration of a high pressure accumulator is shown and generally identified at reference numeral 46′. High pressure accumulator 46′ can be similar to high pressure accumulator 46 such that only differences will be discussed in detail and like reference numerals refer to like or similar components and/or features. High pressure accumulator 46′ can include a thermal energy storage layer 172 between the heat exchanger 110 and the insulating layer 158, as shown in FIG. 2A. The thermal energy storage layer 172 can be configured to retain thermal energy (e.g., store heat input from the exhaust waste heat) over extended periods of time and can include materials/compositions including phase change materials configured to efficiently store heat over extended periods of time. Examples of phase change materials include metallic salts and eutectic metals. It should be appreciated, however, that other phase change materials and/or other materials capable of efficiently storing heat over extended periods of time can be used for the thermal energy storage layer 172.

The hydraulic hybrid vehicle 10 can include a duty cycle that often includes extended periods of engine-off operation where exhaust energy in the form of waste heat would not be available to maintain or increase the temperature of the energy storage gas 96 because the vehicle 10 is being powered by the hydraulic energy storage from accumulator 46/46′. During these times of engine-off operation, heat energy stored in thermal energy storage layer 172 from exhaust waste heat during the last time of engine 24 operation can be provided to the accumulator 46 to improve efficiency. This energy storage layer 172 can provide the advantage of maintaining the temperature of the energy storage gas 96 at an elevated temperature relative to ambient for an extended period of time, as well as maintaining the temperature of the hydraulic fluid near operating temperature, especially in cold ambient operating conditions.

In operation, the controller 168 can control the diverter valve 122 of the exhaust energy recovery system 18 to direct all or a portion of the exhaust gas 152 to the heat exchanger 110 in response to pressure and/or temperature data regarding accumulator 46/46′. For example, during engine-on operation of vehicle 10, the controller 168 can command the diverter valve 122 to divert all or a portion of the exhaust gas 152 to the heat exchange 110. In this operating condition, exhaust gas 152 can flow through diverter valve 122, through inlet pipe 144 and into heat exchanger 110.

In particular, in the exemplary implementation illustrated, the exhaust gas 152 can flow through inlet pipe 144 and into the first annular space or ring 132, which can urge the exhaust gas flow 152 to travel circumferentially around the heat exchanger 110 before or in connection with flowing axially in the direction of arrow A through the heat exchange from an inlet side 178 to an outlet side 182. In the exemplary implementation illustrated, the inlet pipe 144 can be perpendicular or substantially perpendicular to the heat exchanger 110 so as to urge the exhaust gas 152 to flow circumferentially around heat exchanger 110 via annular space 132 and thereby flow axially between each of the flow fins 136. The exhaust gas 152 can flow axially along heat exchanger 110 in spaces 186 between the axial flow fins 136 from the inlet side 178 to the outlet side 182, where the exhaust gas can exit the spaces 186 between the axial flow fins 136 and enter the second annular space or ring 140. From annular space 140, the exhaust gas can exit the heat exchanger 110 through outlet pipe 148 and reenter the exhaust pipe 114 downstream of the heat exchange 110.

As briefly discussed above, diverter valve 122 can also be commanded by controller 168 to divert all of the exhaust gas 152 to bypass the heat exchanger 110 such that the exhaust gas 152 flows through the valve 122, through bypass passage 150 and continues flowing downstream through exhaust pipe 114. In this way, possible over-temperature and over-pressure conditions of accumulator 46/46′ can be avoided.

In an implementation of hydraulic hybrid vehicle 10 using accumulator 46′ having thermal energy storage layer 172, exhaust gas 152 flowing through heat exchanger 110 can provide thermal energy not only to the accumulator outer shell 126 and thus the energy storage gas 96 and hydraulic fluid 42 contained therein, but also to the thermal energy storage layer 172 adjacent to or coupled to the outer shell 156. As discussed above, the thermal energy storage layer can store thermal energy from the exhaust gas 152 for extended periods of time and can thereby maintain the temperature of the accumulator 46′ above ambient temperature over extended periods of time when the vehicle 10 is operating in an engine-off condition, including vehicle shutdown.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An exhaust energy recovery system for a vehicle, comprising:
a hydraulic accumulator having an outer shell defining an internal volume containing an energy storage medium;
a heat exchanger coupled to the outer shell and adapted to selectively receive a flow of exhaust gas therethrough, the heat exchanger having an inlet and an outlet each adapted to be fluidly coupled to an exhaust pipe of the vehicle;
a valve associated with the exhaust pipe upstream of the heat exchanger; and
a bypass passage in selective fluid communication with the valve and the exhaust pipe upstream of the valve, the bypass passage providing a flow path for the exhaust gas that bypasses the heat exchanger;
wherein the valve is configured to: i) divert at least a portion of the exhaust gas through the heat exchanger thereby providing thermal energy to at least the energy storage medium of the accumulator, and/or ii) divert at least a portion of the exhaust gas through the bypass passage.

2. The system of claim 1, wherein the internal volume of the accumulator is separated by a flexible barrier into a first space for hydraulic fluid and a second space for the energy storage medium.

3. The system of claim 1, wherein the accumulator includes an axial length and the heat exchanger includes an axial length substantially as long as the accumulator axial length.

4. The system of claim 1, wherein the heat exchanger includes an annular heat exchanger circumferentially encircling the accumulator.

5. The system of claim 4, wherein the heat exchanger includes an outer shell and a plurality of circumferentially spaced apart axial flow fins, the fins providing a spaced apart relationship between the heat exchanger outer shell and the accumulator outer shell.

6. The system of claim 5, wherein the heat exchanger includes an inlet side annular space positioned at an inlet end of the heat exchanger and an outlet side annular space positioned at an opposed outlet end of the heat exchanger, the plurality of circumferentially spaced apart axial flow fins positioned between the inlet side and outlet side annular spaces.

7. The system of claim 6, wherein the inlet side annular space is coupled to the heat exchanger inlet and the outlet side annular space is coupled to the heat exchanger outlet.

8. The system of claim 4, further comprising an annular insulating layer positioned about an outer shell of the heat exchanger.

9. The system of claim 8, further comprising an annular thermal energy storage layer positioned between the outer shell of the heat exchanger and the insulating layer.

10. The system of claim 1, wherein the bypass passage extends from the valve substantially parallel to the accumulator and fluidly couples a portion of the exhaust system downstream of the heat exchange with a portion of the exhaust system upstream of the heat exchange and the valve.

11. The system of claim 1, further comprising a temperature sensor associated with the accumulator and configured to provide data indicative of a temperature of the energy storage medium.

12. A vehicle, comprising:
a hydraulic drive system including a hydraulic accumulator having an outer shell defining an internal volume containing an energy storage medium; and
an exhaust energy recovery system including:
a heat exchanger coupled to the outer shell and adapted to selectively receive a flow of exhaust gas therethrough, including:
a heat exchanger outer shell;
inlet side and outlet side annular spaces positioned at respective opposed inlet and outlet ends of the heat exchanger;
a plurality of circumferentially spaced apart axial flow fins positioned between the inlet and outlet side annular spaces; and
an inlet and an outlet fluidly coupling the respective inlet and outlet side annular spaces to an exhaust pipe of the vehicle;
a valve associated with the exhaust pipe upstream of the heat exchanger; and
a bypass passage in selective fluid communication with the valve, the bypass passage providing a flow path for the exhaust gas that bypasses the heat exchanger;
wherein the valve is configured to: i) divert at least a portion of the exhaust gas through the heat exchanger thereby providing thermal energy to at least the energy storage medium of the accumulator, and/or ii) divert at least a portion of the exhaust gas through the bypass passage.

13. The vehicle of claim 12, wherein the internal volume of the accumulator is separated by a flexible barrier into a first space for hydraulic fluid and a second space for the energy storage medium.

14. The vehicle of claim 12, wherein the accumulator includes an axial length and the heat exchanger includes an axial length substantially as long as the accumulator axial length.

15. The vehicle of claim 12, wherein the heat exchanger includes an annular heat exchanger circumferentially encircling the accumulator, and wherein the axial flow fins provide a spaced apart relationship between the heat exchanger outer shell and the accumulator outer shell.

16. The vehicle of claim 12, further comprising an annular insulating layer positioned about the outer shell of the heat exchanger.

17. The vehicle of claim 16, further comprising an annular thermal energy storage layer positioned between the outer shell of the heat exchanger and the insulating layer.

18. The vehicle of claim 12, wherein the bypass passage extends parallel to the accumulator.
